(19) United States
(12) Patent Application Publication
(10) Pub. No.: US 2004/0071953 A1
(43) Pub. Date: Apr. 15, 2004

(54) Ink formulations and methods

(76) Inventor: Robert T. Sobieski, Charlotte, NC (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/262,545

(22) Filed: Sep. 30, 2002

(51) Int. Cl. C03C 17/00

(52) U.S. Cl. 428/327; 428/323

(57) ABSTRACT

The present invention relates to ink compositions and methods of making and using such ink compositions. More specifically, the present invention relates to environmentally friendly ink compositions that may be applied to a substrate. For example, ink compositions of the present invention may be applied to a substrate comprising volatile organic compounds (VOCs) for reduced emission of VOCs from the substrate. In another example, ink compositions of the present invention may provide desirable adhesion and/or coalescing properties using environmentally friendly component(s).

### FIELD OF INVENTION

The present invention relates to ink compositions and methods of making and using such ink compositions. More specifically, the present invention relates to environmentally friendly ink compositions that may be applied to a substrate. For example, ink compositions of the present invention may be applied to a substrate comprising volatile organic compounds (VOCs) for reduced emission of VOCs from the substrate. In another example, ink compositions of the present invention may provide desirable adhesion and/or coalescing properties using environmentally friendly component(s).

### BACKGROUND

There is an awareness about the quality of the air inside buildings. Recent studies by the U.S. Environmental Protection Agency and other health agencies have shown that indoor air pollutants are typically two to five times (sometimes 10 to 100 times) higher than levels found in outside air. Due to the awareness of indoor air pollutants, there is a strong desire to control the levels of such pollutants inside structures.

One class of pollutants that has been identified includes certain volatile organic compounds (i.e., VOCs). Generally, VOCs are volatile organic compounds that contain the element carbon, nitrogen, oxygen, and/or hydrogen. In some applicable regulations, the definition of VOCs excludes one or more of methane, carbon monoxide, carbon dioxide, carbonic acid, metallic carbides and carbonates, ammonium carbonate, and exempt compounds, such as methylene chloride and 1,1,1-trichlorethane. Since VOCs seem to be ubiquitous, much attention has been given to identifying the source of certain VOCs and reducing their emissions.

VOCs are emitted and become airborne from a surprising number of articles, particularly from virtually all resin-based man-made materials, that are typically used in homes, office buildings, retail shops, and the like. For example, sources of VOCs include products manufactured of, e.g., thermoplastic and thermoset polymers. Examples of such polymers include polyvinyl chloride (PVC), polyesters such as poly(ethylene terephthalate) (PET), polyurethanes, thermoplastic rubbers, acrylonitrile/butadiene/styrene terpolymers (ABS resins), chlorinated polyethylene. Products made from such materials that tend to emit VOCs into the indoor environment include, for example, wallcovering materials, floorcoverings, ceiling tiles, decorative laminates, cleaners, varnishes, coatings, printed goods (e.g., posters, books, and magazines), inks, paint coverings, packaging, furniture, carpets, equipment, appliances and so forth. For example, formaldehyde tends to be emitted from furniture made from particle board materials, which are wood based materials fixed in a resin binder system.

Additionally, some products utilize organic solvent components, some of which may be undesirable VOCs, to obtain desired processing properties. Such products may include printing inks, varnishes, coatings, and cleaners. For example, printing inks may be applied using binders, adhesion promoters, coalescing agents, and other adjuvants which tend to be sources of VOCs in materials that are printed, such wallcovering materials, floorcoverings, ceiling tiles, decorative laminates, printed goods (e.g., posters, books, and magazines), paint coverings, packaging, furniture, carpets, equipment, appliances and so forth. In particular, N-methyl-2-pyrrolidone is typically used as both an adhesion promoter and coalescing agent. N-methyl-2-pyrrolidone by certain environmental agencies as a pollutant.

Thus, there is a strong desire to reduce the emission of VOCs into the indoor environment from such products as, e.g., wallcovering materials, floorcoverings, ceiling tiles, decorative laminates, cleaners, varnishes, coatings, printed goods (e.g., posters, books, and magazines), inks, paint coverings, packaging, furniture, carpets, equipment, appliances and so forth.

### SUMMARY

In accordance with one aspect of the present invention, there are provided ink compositions that are environmentally friendly. Preferred embodiments are an insignificant source of VOCs themselves. In certain preferred embodiments, an at least partially cured ink composition is applied to a substrate containing one or more VOCs, wherein the at least partially cured ink composition is incompatible with one or more of the VOCs. In still other preferred embodiments, the practical effect of such at least partially cured ink compositions is to provide a containment coating. In still other preferred embodiments, there are provided ink compositions that may use coalescing agents and/or adhesion promoters which reduce the use of N-methyl-2-pyrrolidone by replacing a suitable amount of N-methyl-2-pyrrolidone with a suitable amount of an environmentally friendly solvent.

One embodiment of the present invention includes an in ink composition comprising an inorganic pigment colorant, a binder that is at least an ionomerically crosslinkable binder, together with water. Preferably, the binder comprises a polymer having acid or acid precursor groups, the polymer having an acid number of at least about 3, and the ink composition further comprises an ionomeric crosslinking agent.

Another embodiment of the present invention includes a printed substrate comprising a substrate comprising one or more VOC components, an ink composition that is applied onto the substrate, wherein the ink composition is at least partially cured. Typically, the ink composition comprises an inorganic pigment colorant, a binder that is at least an ionomerically crosslinkable binder, wherein the binder comprises a polymer having acid or acid precursor groups, the polymer having an acid number of at least about 3, an ionomeric crosslinking agent, and water.

Another embodiment of the present invention includes a method of formulating an ink composition, the method comprising a first step of determining that a substrate comprises one or more VOCs, wherein the substrate is one on which an ink composition will be used and a second step of formulating an ink composition based on information in the first step, wherein an at least partially cured ink composition is incompatible with one or more of the VOCs in the first step.

Yet another embodiment of the present invention includes a method of formulating an ink composition, the method comprising a first step of determining that a substrate comprises one or more VOCs, wherein the substrate is one on which an ink composition will be used and a second step of formulating an ink composition based on information in the first step, wherein the at least partially cured ink composition comprises an at least partially cured ink composition that is incompatible with one or more of the VOCs in the first step and comprises a containment coating with respect to one or more of the VOCs in the first step.

Yet another embodiment of the present invention includes a method of reducing the amount of N-methyl-2-pyrrolidone used in an ink composition, the method comprising the steps of determining an ink composition that uses N-methyl-2-pyrrolidone as an adjuvant and reformulating the ink composition by replacing a suitable amount of N-methyl-2-pyrrolidone with an environmentally friendly adjuvant.

Still another embodiment of the present invention includes a method of using a containment coating, comprising providing a substrate comprising one or more VOC components, applying an ink composition onto the substrate, and allowing the ink composition to at least partially cure, thereby forming a containment coating. Typically, the ink composition comprising: an inorganic pigment colorant, a binder that is at least an ionomerically crosslinkable binder, wherein the binder comprises a polymer having acid or acid precursor groups, the polymer having an acid number of at least about 3, an ionomeric crosslinking agent, and water.

### DETAILED DESCRIPTION

As used herein, the term “printed substrate” means a substrate that contains an at least partially cured ink composition. The ink composition may used to form a desired printed image, e.g., a printed letter, shape, or the like. The ink composition may be applied via any suitable means, e.g., as described below.

As used herein, the term “acid number” means the weight in milliequivalents of potassium hydroxide (KOH) required to neutralize acid groups in a gram of polymer.

As used herein, the term “acid precursor number” means the theoretical weight in milliequivalents of potassium hydroxide (KOH) required to neutralize acid precursor groups in a gram of polymer.

As used herein, the term “incompatible” means that an at least partially cured ink composition of the present invention that has been applied to a substrate containing one or more VOCs has a relatively low affinity for one or more of such VOCs. One exemplary quantitative definition of “incompatible” as used in the present invention includes the VOC Incompatibility Test described below. For example, an at least partially cured ink composition of the present invention applied to a substrate containing one or more VOCs is “incompatible” with one or more of such VOCs if it passes the appropriate VOC Incompatibility Test.

As used herein, the term “containment coating” means an at least partially cured ink composition of the present invention applied to a particular substrate containing one or more VOCs, such that the at least partially cured ink composition may reduce or eliminate the emissions of one or more of the VOCs contained in the particular substrate. For example, the at least partially cured ink composition may form an image on substrate comprising one or more VOCs, thereby reducing the surface area of the substrate that is available to emit one or more VOCs into the indoor environment. For example, reducing substrate surface area exposed to indoor environment in the range from 0.5 to 99.5%. More preferably from 1 to 99%. Even more preferably from 5 to 95%. Still more preferably from 10-90%. In one embodiment, the substrate surface area exposed to the indoor environment is less than 70%. In another embodiment, less than 60%. In still another embodiment, less than 50%. In yet another embodiment, less than 40%. In yet another embodiment, less than 30%. In yet another embodiment, less than 20%. In yet another embodiment, less than 10%. In yet another embodiment, less than 5%. In some embodiments, reducing the available surface area of the substrate results in the emission of one or more VOCs being reduced. In other embodiments of the present invention, the at least partially cured ink composition may form an image that substantially covers the entire substrate surface exposed to the indoor environment, thereby, in practical effect, eliminating the surface area of the substrate that is available to emit one or more VOCs into the indoor environment. That is, the substrate surface area available to emit one or more VOCs is, in practical effect, 0%. Typically, such an at least partially cured ink composition of the present invention that partially or substantially cover the underlying substrate may reduce the emission of one or more VOCs in the substrate into the indoor environment. In one embodiment, ink compositions of the present invention are applied onto a substrate (i.e., a substrate comprising one or more VOCs) at a dry ink composition weight of about 2.5 g/sq. yard such that after at least partially curing the ink composition a containment coating is formed that reduces the emission of one or more VOCs from the substrate by about 10% or less. In other embodiments, such an ink composition may provide a containment coating that may reduce the emission of one or more VOCs from the substrate as follows: by about 15% or less; by about 20% or less; by about 25% or less; by about 30% or less; by about 50% or less; by about 75% or less; by about 90% or less; and by about 95% or less. An exemplary test for measuring the effectiveness of a “containment coating” is described below as the VOC Containment Test.

In accordance with one aspect of the present invention, there are provided ink compositions that are environmentally friendly. Preferred embodiments are an insignificant source of VOCs themselves. In certain preferred embodiments, an at least partially cured ink composition is applied to a substrate containing one or more VOCs, wherein the at least partially cured ink composition is incompatible with one or more of the VOCs. In still other preferred embodiments, the practical effect of such at least partially cured ink compositions is to provide a containment coating. In still other preferred embodiments, there are provided ink compositions that may use coalescing agents and/or adhesion promoters which reduce the use of N-methyl-2-pyrrolidone by replacing a suitable amount of N-methyl-2-pyrrolidone with a suitable amount of an environmentally friendly solvent.

An exemplary ink composition of the present invention includes a colorant, an ionomeric crosslinkable binder, an ionomeric crosslinking agent, and a fluid carrier. Optionally, a coalescing agent and/or an adhesion promoter may be used.

Useful colorants include pigments (organic and inorganic), dyes, and chromophores, or combinations thereof. Such colorants are described in, e.g., U.S. Pat. Nos. 4,284,729; 4,398,955; 5,667,580; 6,113,680; 5,837,045; 6,083,315; 5,714,526; 6,117,225. Preferred colorants include inorganic pigments.

Any inorganic pigment colorant can be used without limitation. Inorganic pigments useful in the present invention include, e.g., titanium dioxide (commercially available from, e.g., DuPont Company, Huntsman Tioxide Americas, and Kronos U.S., Inc.), carbon black (commercially available from, e.g., Degussa Corporation, LANSCO COLORS), animal black, Barium sulfate (precipitated (blanc fixe)), barytes pigments, black pigments (other than carbon black) (commercially available from, e.g., LANSCO COLORS, Noveon, Inc.), bone black, chrome pigments (chrome green, chrome yellow, chrome orange), inorganic color pigments, ferric oxide pigments, iron blue pigments (commercially available from, e.g., Degussa Corporation, LANSCO COLORS), iron colors, iron oxide (black), iron oxide (magnetic), iron oxide (yellow), lamp black, lead oxide pigments, lead pigments, litharge, lithopone, inorganic metallic pigment, mineral pigment, minium (pigment), ochers, inorganic paint pigment, pearl essence pigment, prussian blue pigment, red lead pigment, satin white pigment, sienna, titanium pigment, ultramarine pigment, umber, vermilion pigment, white lead pigment, whiting, zinc oxide pigment, zinc pigment (e.g., zinc yellow and zinc sulfide).

Representative useful pigment particle sizes include pigment particle size values in the range from 0.1 micrometers to 35 micrometers. Preferred pigment particle size values include size values in the range from 0.1 micrometers to 9 micrometers. Even more preferred pigment particle size values include size values in the range from 0.2 micrometers to 4 micrometers.

Representative useful pigment loading values include from loading values from 10 to 99 percent by weight inorganic pigment colorant. Preferred loading values include loading values from 20 to 80 percent by weight inorganic pigment colorant. Preferably, the loading value is at least 40 percent by weight inorganic pigment colorant. Even more preferably, the loading value is at least 50 percent by weight inorganic pigment colorant.

Useful methods for producing and preparing pigments include any suitable comminuting method, e.g., ball milling and grinding. These and other exemplary useful methods are further described in U.S. Pat. Nos. 5,667,580; 6,113,680; 6,133,366.

A useful ionomeric crosslinkable binder includes a polymer having functionality capable of forming a crosslinking ionomeric bond. Preferably, the polymer comprises acid functionality or acid functionality precursors that can form an ionic bond with a cationic ionomeric crosslinking agent (e.g., zinc ammonium or zinc ammonium carbonate). For purposes of the present invention, an acid functionality precursor is any functional group on the polymer that may be converted, for example by hydrolysis or the like, to an acid functionality that is capable of forming an ionic bond with a cationic crosslinking agent.

Preferred ionomerically crosslinkable binder(s) include a polymer having acid or acid precursor groups, the polymer having an acid number of at least about 3.

In certain preferred embodiments, ionomeric crosslinkable binder comprises carboxylic acid functionality or sulfonic acid functionality. In addition, other acids can also be incorporated into the polymer backbone, such as functionality derived from acrylic acid or methacrylic acid.

In one embodiment of the present invention, the polymer to be used in the ink composition is a carboxylic acid functional polymer that is a copolymer prepared from polymerization of one or more unsaturated aliphatic carboxylic acids and esters, with one or more other reactive monomers such as acrylamide, acrylonitrile, vinyl chloride, allyl chloride, vinyl acetate, and ethylenically unsaturated groups such as ethenyl and 2-propenyl. Ter- and higher polymers can also be used. In this copolymer system, the unsaturated aliphatic carboxylic acids of this copolymer are preferably, for example, one or more of acrylic acid, 2-chloroacrylic acid, 3-chloroacrylic acid, 2-bromoacrylic acid, 3-bromoacrylic acid, methacrylic acid, itaconic acid, maleic acid, glutaconic acid, aconitic acid, citraconic acid, mesaconic acid, fumaric acid, tiglic acid and maleic anhydride.

In a preferred embodiment, the polymer of the aqueous ink composition is a vinyl chloride/(meth)acrylate co-polymer emulsion. Most preferably, these polymers comprise at least about 80% of vinyl chloride that is co-polymerized with up to about 20 percent of acrylate or methacrylate functionality. Particularly preferred such polymers include XPD-2111 polymer and TO-81 polymer, both produced by Noveon, Inc. (previously known as BF Goodrich).

In another preferred embodiment, the polymer of the aqueous ink composition is an acrylonitrile/(meth)acrylate co-polymer emulsion. Most preferably, these polymers comprise about 35-50 percent acrylonitrile in the copolymer. Particularly preferred such polymers include Rhoplex 1691 polymer, commercially available from Rohm & Hass. This class of polymer has been found to exhibit excellent chemical and barrier resistance.

In another preferred embodiment, the polymer of the aqueous ink composition is an ethylene/vinyl chloride copolymer system. Most preferably, these polymers comprise about 50-75 percent of vinyl chloride in the copolymer. Particularly preferred such polymers are commercially available from Air Products, Inc. as Airflex® 4500, 4513, 4532 polymers.

In another preferred embodiment of the present invention, the polymer to be used in the aqueous ink composition may be a polycarbonate urethane polymer. These polymers may actually be either aromatic or aliphatic in nature, provided that they have acid functionality such that they are ionomeric the cross-linkable. Particularly preferred such polymers are commercially available as 66-012 polymer from Stahl USA (Boston, Mass.). In a particularly preferred aspect of this invention, the polymer may additionally be provided with a covalent crosslinking system to provide further resiliency of the ink on the substrate. Most preferably, this polymer is further cross-linked with melamine to provide covalent cross-links. Melamine is particularly preferred as a covalent crosslinking agent because it is easily incorporated in aqueous systems and exhibits relatively low toxicity. This ink composition is particularly advantageous, because it has a combination of some covalent crosslinks, in combination with ionomeric crosslinks.

In another preferred embodiment of the present invention, the polymer to be used in the aqueous ink composition may be vinylidene chloride. Particularly preferred such polymers are commercially available as Hycar™ 260912 polymer from Noveon Inc.

The ink compositions of the present invention optionally may comprise a blend of polymers that comprise ionically crosslinkable functionality. Additionally, the ink compositions of the present invention may further comprise blends of polymers that comprise ionically crosslinkable functionality, together with polymers that do not comprise ionically crosslinkable functionality.

In certain embodiments of the present invention, the crosslinks of the ionomerically crosslinkable binder may be thermally reversible crosslinks. These embodiments may provide particular benefit in that the resulting products may be more readily recycled. That is, such crosslinks may be readily removed when desired, simply by exposing such crosslinks to alkali conditions that tend to disrupt the ionic bond of the ink.

In an alternative embodiment of the present invention, the polymers of the ink comprise a substantial degree of crosslinking from covalent bonds, as well as from ionic bonds. These substantially convalently crosslinked embodiments are stable to exposure to alkali solutions.

In a preferred embodiment, the binder used in an ink composition of the present invention is polymerized using emulsion polymerization. This type of polymerization is preferred because it may incorporate functionality useful for generating the ionomeric crosslinks that are useful in ink compositions of the present invention. Useful emulsion polymerizations contain water, thus an initiator used in such a polymerization is preferably water soluble, and will typically introduce acid functionality to at least the end groups of the polymers that are being formed.

In one aspect of the present invention, the ionomerically crosslinkable binder may have a relatively low initial Tg, which provides particular benefit in forming a suitable printed substrate. Thus, due to the desirable behavior of the ink compositions made with ionomerically crosslinkable binder having a relatively low initial Tg, a suitable ink composition of the present invention may be obtained with little or no addition of coalescing agent(s), which may themselves be VOCs. This is particularly the case where the chemical nature of the ionomerically crosslinkable binder in the ink composition is similar to the chemistry of the substrate to be printed. For example, an ionomerically crosslinkable binder comprising vinyl chloride functionality may exhibit suitable affinity to a PVC substrate, and provide a suitable printed substrate without the use of a coalescing agent.

In a low Tg embodiment, the Tg of the ionomerically crosslinkable binder may be selected to be about 0-70° C. After an ink composition of the present invention is applied onto a surface of the substrate and has at least partially cured, the ionic interactions occur, thereby creating the ionic crosslink matrix. This crosslink matrix raises the effective Tg of the at least partially cured ink composition to a much higher temperature, thereby hardening the at least partially cured ink composition to a degree typically not achievable without the ionic crosslinking component. Surprisingly, at least partially cured ink compositions of the present invention have sufficient flexibility to be applied to a flexible vinyl film without fracturing during ordinary flexing operations of the film. While not being bound by theory, is believed that ionomeric crosslinking, as used in the present invention, provides sufficient internal cohesion within the at least partially cured ink composition such that structural integrity is maintained even upon application of stress to the composition.

In another embodiment of the present invention, the ionomeric crosslinkable binder has an initial Tg of greater than about 70° C. Such an embodiment may require the additional use of a coalescing agent to assist in uniform formation of a coating. Similarly, as described above, these higher Tg ionomeric crosslinkable binders tend to exhibit greater affinity for the substrate if the chemistry of the binder contains functionality in common with the substrate.

Optional ionomeric crosslinking agent(s) is additionally provided in the ink composition that is capable of ionically crosslinking the ionomeric crosslinkable binder. Useful ionomeric crosslinking agents include epoxy functionalized ethylene copolymer crosslinking agent, peroxide crosslinking agent, and zinc. Such ionomeric crosslinking agents are further described in, e.g., U.S. Pat. Nos. 5,162,427 and 6,153,680.

Preferred crosslinking agent includes cationic crosslinking agent such as zinc. Most preferably provided as a coordination compound of zinc ammonium or zinc ammonium carbonate. Convenient compositions for providing zinc are commercially available as ZINPLEX 15. The ionomeric crosslinking agent may be provided in an amount sufficient to provide ionomeric crosslinking in the inventive ink composition to provide a suitable printed substrate. Preferably, the ionomeric crosslinking agent is present in an amount sufficient to neutralize essentially all of the acid functionalities of the ionomeric crosslinking binder. Most preferably, the ionomeric crosslinking agent is added in excess of the amount required to neutralize all of the acid functionalities of the ionomeric crosslinkable binder.

Because ink compositions of the present invention preferably comprise water as a fluid carrier, the acid functional polymer or polymers containing precursors to acid functionality may be provided in a single solution together with an ionomeric crosslinking agent. This composition is typically stable, because the ionomeric crosslinks do not form until the ink composition is at least partially cured. Conversion of acid precursors to the corresponding acid may optionally be carried out prior to application of the ink composition to the substrate, or alternatively may be carried out during application. The preferred conversion is by hydrolysis of precursors, assisted by heating the ink composition to a temperature effective to undergo hydrolysis of the particular acid precursor.

Representative useful amounts of ionomeric crosslinking agents include from 1 to 3 weight percent. Preferably, from 1 to 2 weight percent.

Useful fluid carrier includes, e.g., water and organic solvents. Typical organic solvent includes methyl ethyl ketone. Preferred fluid carrier in the present invention includes water.

Generally, an environmentally friendly adjuvant includes a fluid that is biodegradable in normal sewerage treatment plants, and has a low volatile content of regulated VOCs so that it can be used indoors with minimal ventilation. Adjuvants used in the present invention include coalescing agents, adhesion promoters, surfactants, and the like. Useful environmentally friendly adjuvants include, e.g., lactate esters (e.g., methyl lactate, ethyl lactate, propyl lactate, and butyl lactate) and edible oil-derived ester solvents. A preferred environmentally friendly solvent in the present invention includes ethyl lactate. This and other useful environmentally friendly solvents are described in U.S. Pat. No. 6,191,087.

Useful methods for producing and preparing environmentally friendly adjuvants, include, e.g., simultaneous hydrolysis of dimers or highpolymers of lactic acid present in commercial lactic acid to free lactic acid and esterification of free lactic acid with an alcohol in the presence of water. These and other exemplary useful methods are further described in U.S. Pat. No. 6,342,626.

Environmentally friendly adjuvants are commercially available. For example, ethyl lactate is commercially available from NTEC-Versol, Mount Prospect, Ill.

Many environmentally friendly adjuvants can be used in the present invention as coalescing agents and/or adhesion promoters to reduce the use of N-methyl-2-pyrrolidone.

One or more adhesion promoters may optionally be used in the present invention. For example, in the case of ionomeric crosslinkable binders and/or inorganic pigment colorants that do not by themselves afford sufficient adhesion to the intended substrate, adhesion promoters may be added to an ink composition used in the present invention. Suitable adhesion promoters include N-methyl-2-pyrrolidone and/or environmentally friendly adhesion promoters, e.g., alkyl lactates (e.g., ethyl lactate). These adhesion promoters are preferably present an amount greater than about one percent by weight, but less than about eight percent by weight and more preferably from about two to about five percent by weight. The need for adhesion promoters in ink compositions of the present invention may be determined by routine empirical evaluation of various ink compositions on the intended substrate. In the event that the adhesion promoter is a relatively low boiling solvent, such adhesive promoter is preferably present in a sufficiently low amount so that the Flash Cup Rating of the overall ink composition is above 212° F.

One or more coalescing agents may optionally be used in the present invention. For example, ionomeric crosslinkable binders and/or inorganic pigment colorants of the present invention and a coalescing agent interact to form a suitable printed substrate. Suitable adhesion promoters include N-methyl-2-pyrrolidone and/or environmentally friendly adhesion promoters, e.g., alkyl lactates (e.g., ethyl lactate). These adhesion promoters are preferably present an amount greater than about one percent by weight, but less than about eight percent by weight and more preferably from about two to about five percent by weight. The need for coalescing agents in ink compositions of the present invention may be determined by routine empirical evaluation of various ink compositions on the intended substrate. In the event that the coalescing agent is a relatively low boiling solvent, such coalescing agent is preferably present in a sufficiently low amount so that the Flash Cup Rating of the overall ink composition is above 212° F. Exemplary useful coalescing agents are further described in U.S. Pat. No. 6,361,826.

Environmentally friendly adjuvants can be used to reduce the amount of N-methyl-2-pyrrolidone used as one or more of, e.g., an adhesion promoter and coalescing agent of the present invention. In certain embodiments, one part of N-methyl-2-pyrrolidone can be reduced by using 0.75 parts of an environmentally friendly adjuvant (e.g., an alkyl lactate). In one embodiment, an environmentally friendly adjuvant can reduce the amount of N-methyl-2-pyrrolidone in an ink composition of the present invention to less than 7% by total ink composition weight of N-methyl-2-pyrrolidone. More preferably, an environmentally friendly adjuvant can reduce the amount of N-methyl-2-pyrrolidone in an ink composition of the present invention to less than 4% by total ink composition weight of N-methyl-2-pyrrolidone. In one embodiment an environmental friendly adjuvant, ethyl lactate, is more volatile than N-methyl-2-pyrrolidone and flashes off during the application of an ink composition of the present invention to a substrate. In one embodiment, up to 10% of ethyl lactate may be used to reduce the amount of N-methyl-2-pyrrolidone used.

Particularly preferred substrates include wallcovering materials (e.g., vinyl wallcoverings and wallcoverings made from other plastic materials or comprising plastic as a component), floorings, floorcoverings, ceiling tiles, decorative laminates, cleaners, varnishes, coatings (e.g., powder coatings and/or coatings described in Applicant's copending Application titled “VOC Containment Coating, Methods and Articles” and filed on Sep. 30, 2002), printed goods (e.g., posters, books, and magazines), inks, paint coverings, packaging, furniture (e.g., vinyl furniture or wood furniture), materials made from particle board, carpets, equipment, appliances and so forth. Other substrates include those described in Applicant's copending Application titled “Halogen-Containing Vinyl Polymer Compositions,” “Halogen-Containing Vinyl Polymer Compounds,” and “Halogen-Containing Vinyl Polymer Stabilizers”, and each filed on Sep. 30, 2002. At least some of the preferred substrates may be in the form of a web.

Preferred powder coating substrates include coated metal articles such as used to fabricate household appliances and the like. Powder coating is a process of providing a surface with an excellent, often very durable, coating.

Filler may also be incorporated as desired into an ink composition of the present invention to provide, e.g., a suitable printed substrate. More specifically, the filler may preferably be selected from non-reinforcing fillers such as mineral fillers, glass bubbles and the like, or may be selected from polymeric resins. Preferred filler includes TiO2. Often such filler is provided in a polymeric resin carrier, which is appropriately included as a part of the filler material mass for measurement purposes.

Additional components may be added to the ink composition in order to provide desired properties of the intermediate ink composition and the at least partially cured ink composition. For example, additives may be provided to enhance coatability, color, modify viscosity, fragrances and the like.

Other exemplary additives include anti-oxidants and UV stabilizers.

Methods for applying ink are well known and are described in, e.g., U.S. Pat. Nos. 4,791,881; 4,672,893; 5,098,477. Any suitable method can be used without limitation. Suitable methods for applying an ink composition of the present invention include, e.g., offset printing, letterpress printing, flexographic printing, gravure printing, flexo-gravure printing, and combinations thereof.

After application of an ink composition of the present invention to a substrate, the ink composition is at least partially cured and stable ionomeric crosslinks may be formed. These crosslinks may be stable in non-alkali conditions. If it is desired to remove the cross-link matrix from the substrate, and alkali composition such as ammonium water may be applied to the coating, which typically disrupts the ionomeric crosslinks, thereby typically allowing the at least partially cured ink composition to be removed from a substrate.

Methods of at least partially curing an ink composition that includes an ionomeric crosslinkable binder and ionomeric crosslinking agent are well known. For example, an ink composition of the present invention applied to a substrate may be at least partially cured by, e.g., letting the composition air dry at ambient conditions or by removing water from the ink composition with the aid of radiant or thermal (e.g., greater than ambient temperature air). In order to provide a suitable at least partially cured ink composition with as little introduction of VOCs to an environment as possible, preferably the ink composition is at least partially cured by application of energy such as a hot air stream or radiant energy. In products wherein the ink composition is applied to a substrate as part of a continuous web process, the printing device is preferably installed in line with the web manufacturing equipment and the heating elements or other energy device are preferably installed downweb from the printing equipment so that heat or other form of energy is applied shortly after ink composition is applied onto the substrate. Alternatively, the ink composition may be applied to a substrate as a separate application step after complete manufacture of the substrate.

Ink compositions of the present invention that have been applied to a substrate and at least partially cured may be formulated to be “incompatible” with the substrate and/or to provide “containment coatings.” In one embodiment, a method of formulating an ink composition of the present invention comprises a first step of determining that one or more VOCs are contained in a substrate on which an ink composition will be used and a second step of formulating an ink composition based on information in the first step, wherein the at least partially cured ink composition is incompatible with one or more of the VOCs in the first step.

Typically, at least one VOC in the substrate is phenol. Preferably, the first step comprises the Volatile Ingredient Evaluations. Preferably the evaluation of the incompatibility of the at least partially cured ink composition with the one or more VOCs in the second step comprises the VOC Incompatibility Test.

The Volatile Ingredient Evaluations test and the VOC Incompatibility Test are exemplary tests and are described below.

In another embodiment, a method of formulating an ink composition of the present invention comprises a first step of determining that one or more VOCs are contained in a substrate on which an ink composition will be used and a second step of formulating an ink composition based on information in the first step, wherein the at least partially cured ink composition is incompatible with one or more of the VOCs in the first step and forms a containment coating with respect to one or more of the VOCs in the first step within the substrate.

Typically, at least one VOC in the substrate is phenol. Preferably, the first step comprises the Volatile Ingredient Evaluations. Preferably the evaluation of the incompatibility of the at least partially cured ink composition with the one or more VOCs in the second step comprises the VOC Incompatibility Test. Preferably, the evaluation of the at least partially cure ink composition to form a containment coating with respect to one or more VOCs in the first step comprises the Phenol Containment Test.

Ionomeric crosslinkable binders that may be particularly useful in ink compositions of the present invention to form “containment coatings” may be selected such that they will form an at least partially cured ink composition that is sufficiently incompatible with one or more VOCs to be contained as to pass a VOC Incompatibility Test, and additionally comprise acid or acid precursor functionality to have an acid number of at least about 3.

At least partially cured ink compositions of the present invention that are incompatible with one or more VOCs in a substrate and/or provide useful containment coatings for one or more VOCs in a substrate may be used on practically any suitable substrate that is capable of emitting one or more VOCs into an indoor environment.

Particularly preferred substrates include wallcovering materials (e.g., vinyl wallcoverings and wallcoverings made from other plastic materials or comprising plastic as a component), floorings, floorcoverings, ceiling tiles, decorative laminates, varnishes, coatings (e.g., powder coatings and/or coatings described in Applicant's copending Application titled “VOC Containment Coating, Methods and Articles” and filed on Sep. 30, 2002), printed goods (e.g., posters, books, and magazines), inks, paint coverings, packaging, furniture (e.g., vinyl furniture or wood furniture), materials made from particle board, carpets, equipment, appliances and so forth. Other substrates include those described in Applicant's copending Application titled “Halogen-Containing Vinyl Polymer Compositions,” “Halogen-Containing Vinyl Polymer Compounds,” and “Halogen-Containing Vinyl Polymer Stabilizers”, and each filed on Sep. 30, 2002. At least some of the preferred substrates may be in the form of a web.

Preferred powder coating substrates include coated metal articles such as used to fabricate household appliances and the like. Powder coating is a process of providing a surface with an excellent, often very durable, coating.

While in one aspect, the process of ink compositions of the present invention being applied to a substrate and at least partially cured are preferably applied in the manufacturing operation, alternatively the process may be applied on site to control emission of VOCs in an existing structure.

The Volatile Ingredient Evaluations test, VOC Incompatibility Test, and the Phenol Containment Test are exemplary tests and are described below. An ink composition of the present invention may be determined to be incompatible with a particular VOC by routine evaluation using the VOC Incompatibility Test, described as follows. An ink composition of the present invention is applied onto a substrate at a dry ink composition weight of about 2.4 g/sq yard. The composition is allowed to at least partially cure with ionic crosslinking under ordinary conditions appropriate for application of the composition to the desired substrate. A 3 ml drop of VOC target component is applied to the at least partially cured ink composition, and a watchglass is placed over the top of the VOC target component drop and allowed to stand at room temperature (about 25 C) for about 4 hours. The watchglass is then removed, and the at least partially cured ink composition is visually inspected for discontinuities. The at least partially cured ink composition is deemed to pass the VOC Incompatibility Test if there is no blistering or defect in the at least partially cured ink composition as determined by visual inspection by the unaided eye. The evaluation of the coating is preformed as described in ASTM D 1308.

Most preferably, an at least partially cured ink composition of the present invention passes the VOC Incompatibility Test with the compound or the combination of VOC target compounds that are particularly identified as problematic for a particular substrate and/or a particular environment of use of the ultimate article. For example, in the case of vinyl films, containment of phenol and N-methyl-2-N-methyl-2-pyrrolidone is of primary importance to provide films having much lower VOC emission as compared to films without the at least partially cured ink composition of the present invention. Likewise, certain furniture articles made from pressboard materials, containment of formaldehyde is of primary importance, and an at least partially cured ink composition of the present invention that passes the VOC Incompatibility Test for formaldehyde is preferred, regardless of its performance relative to other VOCs such as phenol.

It has been found that at least partially cured ink compositions of the present invention that are incompatible with phenol are generally effective in containing many if not most of the other offending VOCs, so that an at least partially cured ink composition that has passed a VOC Incompatibility Test wherein the VOC target component is phenol generally has use beyond merely containing phenol. Thus, preferably the at least partially cured ink composition passes a VOC Incompatibility Test for phenol. Additionally, the at least partially cured ink composition preferably passes the VOC Incompatibility Test wherein the VOC target compound is one or more of N-methyl-2-N-methyl-2-pyrrolidone, ethylene glycol, formaldehyde, 2-butoxy ethanol, dodecanol, nonadecanol, hexane, dodecene, methylene heptane, trimethyl cyclohexane, undecane, 1-methyl-2-(3-methylpentyl) cyclopropane, and 2-ethyl hexanoic acid. Preferably the continuous coating layer is incompatible with a mono-component solution made from of at least one member of the group consisting of phenol, formaldehyde, dodecane, hexane and N-methyl-2-N-methyl-2-pyrrolidone.

As a particularly preferred embodiment of a containment coating, an at least partially cured ink composition of the present invention is provided as an “all purpose” containment coating that is effective in containing a wide variety of VOC compounds. In this embodiment, the containment coating passes the VOC Incompatibility Test for a specific selection of VOC target compounds, which is phenol, formaldehyde, dodecane, hexane and N-methyl-2-N-methyl-2-pyrrolidone. In this evaluation, the VOC Incompatibility Tests are preferably performed individually on each of the VOC target compounds. At least partially cured ink compositions of the present invention that pass the VOC Incompatibility Test for all five of the above compounds are particularly preferred for use as an “all purpose” containment coating.

Volatile Ingredient Evaluations are made by loading product to be tested into a controlled environmental chamber. The sample is collected, placed in the environmental chamber, and allowed to equilibrate within the chamber prior to running the Volatile Ingredient Evaluation.

The environmental chamber is sized to allow testing at the same loading ratio of exposed surface area to room volume as found in a typical indoor environment, so that the results of the chamber testing are scalable to any size room. Typically, the environmental chambers are provided in a size in the range of approximately 0.5 m³ to approximately 26 m³ (which would simulate room size). The walls and doors of the environmental chamber are constructed of polished stainless steel with inert seals. The test chamber is designed to meet construction specifications and performance requirements established by the U.S. EPA guidelines and ASTM Standard D5116-97, “Standard Guide for Small Scale Chamber Determination of Organic Emissions from Indoor Materials/Products,” and ASTM Standard D 6670-01, “Standard Practice for Full-Scale Chamber Determination of VOCs from Indoor Materials/Products.” Prior to loading sample into the environmental chamber, background levels can be determined to establish a baseline for testing.

Product to be tested is introduced into the environmental chamber and is allowed to equilibrate with the environmental conditions in the chamber. This equilibration period generally comprises four to twenty-four hours. In a preferred scenario, the equilibration period comprises 12 hours.

During testing, purified air at standard environmental conditions of 23° C. (73.4° F.) and 50% relative humidity is cycled through the environmental test chamber, and these standard conditions are maintained throughout the testing period. The environmental chamber includes inlet air and exhaust air manifold systems that are configured to assure that the air inside the chamber is well mixed, so that an air sample from the center of the chamber contains the same concentration of pollutants (from a product inside the chamber) as an air sample from one of the back corners of the chamber. Environmental conditions of the inlet air and the chamber air can be monitored throughout the test to assure that the test conditions are met and the chamber operates in a stable manner.

Sampled air from the environmental chamber is collected on a solid sorbent and thermally desorbed into a gas chromatograph with mass spectrometric detection (GC/MS). The solid sorbent collection media contains both Carbosieve SIII and Tenax TA. The following instrumentation is used to analyze results: NuTech 8533 Universal Sample Concentrator with a HP 5890 Series II Gas Chromatograph and HP 5971 Series Mass Selective Detector (MSD) or a Perkin-Elmer ATD-400 Thermal Desorbtion System with a HP 6890 GC and HP 5973 MSD.

After collection, the chemicals adsorbed on the sorbent media are thermally desorbed into the capillary GC/MS. Individual VOCs are separated and detected by the GC/MS. Individual VOCs can be quantified (relative to a suitable standard such as toluene) and identified by comparison to known mass spectral data. Mass spectral databases are maintained by Air Quality Sciences, Inc. (AQS, Atlanta, Ga.) and by the Environmental Protection Agency and National Institutes of Health. TVOC measurements are made by adding all individual VOC responses obtained by the mass spectrometer and calibrating the total mass relative to toluene.

A multi-bed collection technique, separation, and detection analysis methodology are described, for example, in Bertoni, G., Bruner, F., Liberti, A. and Perrino, C. “Some Critical Parameters in Collection, Recover, and Gas Chromatographic Analysis of Organic Pollutants in Ambient Air Using Light Adsorbents.” J. Chromatogr., 203, 263-270 (1981); Bertoni, G., Bruner, F. and Crescentini, G. “Critical Evaluation of Sampling and Gas Chromatographic Analysis of Halocarbons and other Organic Air Pollutants.” J. Chromatogr., 167, 399-407 (1978); Mangani, F., Marras, O. and Mastrogiacomo, A. “Evaluation of the Working Conditions of Light Adsorbents and their Use as Sampling Material for the GC Analysis of Organic Air Pollutants in Work Areas.” Chromatographia, 15, 712-716 (1982); Murphy, N. T., Riggan, R. M. and Winberry, W. T. Environmental Protection Agency. Compendium of Methods for the Determination of Toxic Organic Compounds in Ambient Air (EPA Rpt, 600/4-89/017). Washington, D.C.: Environmental Protection Agency (1988), (the disclosures of which are incorporated herein by reference).

The Volatile Ingredient Evaluation follows EPA Method IP-1B and is generally applicable to C₄-C₁₆ organic chemicals with boiling points ranging from 35° C. to 250° C. The evaluation has a detection limit of 0.5 μg/m³ for most IVOCs and TVOCs.

Once the test sample is introduced into the environmental chamber and equilibration has occurred, data is taken over a 96-hour test period. The Volatile Ingredient Evaluation provides three measurements: emission factors, emission rates, and predicted air concentrations. A Volatile Organic Compound Emission Factor is the amount of a chemical that is emitted at a particular point in time. The Emission Factor is measured for a certain exposed area of the product, for example, a square meter of the chloride-containing vinyl polymer film. For example, a chloride-containing vinyl polymer film can emit 50 μg/m²*hr of phenol. This means that every square meter of this chloride-containing vinyl polymer film will emit 50 micrograms of phenol per hour of exposure time. This assumes the product is constantly emitting phenol. If the product is not constantly emitting phenol, but emissions are decreasing over time, the Emission Factor is a qualitative estimate of emissions release at a particular point in time.

An emission rate mathematically describes how a product's emissions change over time. This emission rate requires an environmental chamber test with multiple sampling episodes, over an extended time period (typically, six samples over the 96-hour test period). Several factors can affect the emission rate of a product, including temperature, humidity, air exchange rate, ambient pollutant concentrations, and air velocity. For most interior products, emission rates are either constant (product emissions remain the same over a test period) or they are decreasing (product emissions actually decline over a test period). The emission rate is commonly displayed as a mathematical equation using two characteristic parameters: the initial emission factor and the decay rate. These two parameters define the emission rate profile. The test period is 96 hours with periodic measurement points, for example, at 4, 8, 24, 48, 72 and 96 hours. The Emission Factor describes a product's emissions at one point in time assuming constant emissions. If a product has been shown to be a constant emitter, the Emission Factor and emission rate will be the same. If the product's emissions change over time, it will have a different Emission Factor at every point in time.

The predicted air concentration describes the amount of chemicals or particles contained in a unitized volume of air. When the air in a dynamic chamber is sampled, the mass collected is what is actually measured. The air concentration (expressed in μg/m³) is then derived as the collected mass of the contaminant (in micrograms) divided by the amount of air sampled (cubic meters). The measured air concentration is representative of what a building's occupants would breathe.

To determine a product's predicted air concentration, the product's emission rate must be determined, since the more a product emits pollutants, the greater the exposure concentration of pollutants in a room. The environment in which the product will be used must then be defined. The use environment is described in terms of building air flows, percentage of outside air, room size, amount of product in the space, and possible additional emission sources. These parameters are used in a computer program that models the actual air flows and emissions and calculates the predicted air concentration.

TVOC standards for air concentrations for wallcoverings have been developed by the State of Washington (0.5 mg/m³) and the U.S. Environmental Protection Agency (0.05 mg/m³).

“Containment coatings” of the present invention may be evaluated by techniques known in the art for isolating a product to be evaluated, air sample collection of the headspace over the product, and chemical analysis to identify the amount of one or more VOCs being emitted by the product. In certain embodiments, ink compositions of the present invention that are applied onto a substrate and at least partially cured preferably reduce the amount of one or more VOC(s) emission to a level less than about 500 μg/m²*hour or less.

One specific evaluation technique includes the Volatile Ingredient Evaluations test described above. For example, when phenol is the target VOC, a containment test includes the Volatile Ingredient Evaluations test described above and is referred to herein as “Phenol Containment Test.”

Ink compositions of the present invention may be used in combination with coatings and substrates described in Applicant's copending applicantions titled “VOC Containment Coating, Methods and Articles,” “Halogen-Containing Vinyl Polymer Compositions,” “Halogen-Containing Vinyl Polymer Compounds,” and “Halogen-Containing Vinyl Polymer Stabilizers”, and each filed on Sep. 30, 2002.

All patents, patent documents, and publications cited herein are incorporated by reference as if individually incorporated. Unless otherwise indicated, all parts and percentages are by weight. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A printed substrate comprising:
a. a substrate comprising one or more VOC components; and
b. an ink composition that is applied onto the substrate, the ink composition comprising:
i. an inorganic pigment colorant;
ii. a binder that is at least an ionomerically crosslinkable binder, and
iii. water,
wherein the ink composition is at least partially cured.

2. The printed substrate of claim 1, wherein the binder comprises a polymer having acid or acid precursor groups, the polymer having an acid number of at least about 3; and the ink composition further comprises an ionomeric crosslinking agent.

3. The printed substrate of claim 2, wherein the ionomeric crosslinking agent comprises zinc ammonium or zinc ammonium carbonate.

4. The printed substrate claim 1, wherein the ink composition comprises ethyl lactate.

5. The printed substrate of claim 4, wherein the ink composition comprises less than 7% by weight N-methyl-2-pyrrolidone.

6. The printed substrate of claim 4, wherein the ink composition comprises less than 4% by weight N-methyl-2-pyrrolidone.

7. The printed substrate of claim 1, wherein the substrate comprises a polyvinyl chloride film.

8. The printed substrate of claim 1, wherein the substrate comprises a pressboard.

9. The printed substrate of claim 1, wherein the substrate comprises a painted surface.

10. The printed substrate of claim 1, wherein the substrate comprises a powder coated surface.

11. The printed substrate of claim 1, wherein the ink composition ingredients are present in respective amounts such that the at least partially cured ink composition is incompatible with phenol.

12. The printed substrate of claim 11, wherein the ink composition ingredients are present in respective amounts such that the ink composition is applied onto the substrate at a dry coating weight of at least 2.4 g/sq yard.

13. The printed substrate of claim 1, wherein the at least partially cured ink composition comprises a containment coating.

14. A method of formulating an ink composition, the method comprising:
a. a first step of determining that a substrate comprises one or more VOCs, wherein the substrate is one on which an ink composition will be used; and
b. a second step of formulating an ink composition based on information in the first step, such that after the ink composition is at least partially cured it is incompatible with one or more of the VOCs in the first step.

15. The method of claim 14, wherein at least one VOC in the substrate comprises phenol.

16. The method of claim 14, wherein the first step comprises the Volatile Ingredient Evaluations test.

17. The method of claim 14, wherein the second step comprises the VOC Incompatibility Test.

18. A method of formulating an ink composition, the method comprising:
a. a first step of determining that a substrate comprises one or more VOCs, wherein the substrate is one on which an ink composition will be used; and
b. a second step of formulating an ink composition based on information in the first step, wherein the at least partially cured ink composition comprises an at least partially cured ink composition that is incompatible with one or more of the VOCs in the first step and comprises a containment coating with respect to one or more of the VOCs in the first step.

19. The method of claim 18, wherein at least one VOC in the substrate comprises phenol.

20. The method of claim 18, wherein the first step comprises the Volatile Ingredient Evaluations test.

21. The method of claim 18, wherein the second step comprises the VOC Incompatibility Test.

22. The method of claim 18, wherein the second step comprises the Phenol Containment Test.

23. A method of using a containment coating, comprising:
a. providing a substrate comprising one or more VOC components;
b. applying an ink composition onto the substrate, the ink composition comprising:
i. an inorganic pigment colorant,
iii. a binder that is at least an ionomerically crosslinkable binder,
iii. water; and
c. allowing the ink composition to at least partially cure, thereby forming a containment coating.

24. The method of claim 23, wherein the binder comprises a polymer having acid or acid precursor groups, the polymer having an acid number of at least about 3; and the ink composition further comprises an ionomeric crosslinking agent.

25. The method of claim 23, wherein the containment coating is incompatible with at least phenol.

26. The method of claim 23, wherein the ionomeric crosslinking agent comprises zinc ammonium or zinc ammonium carbonate.

27. The method of claim 23, wherein the applied ink composition is at least partially cured by applying radiant energy to the applied ink composition.

28. The method of claim 23, wherein after at least partially curing the containment coating is incompatible with phenol and N-methyl-2-pyrrolidone.

29. The method of claim 23, wherein the substrate is a chloride-containing vinyl polymer film.

30. The method of claim 23, wherein the substrate is polyvinyl chloride film.

31. The method of claim 23, wherein the ink composition is applied to the substrate at a dry coating weight of at least about 2.4 g/sq yard.

32. The method of claim 23, wherein the substrate comprises a pressboard.

33. The method of claim 23, wherein the substrate comprises a painted surface.

34. The method of claim 23, wherein the substrate comprises a powder coated surface.

35. The method of claim 23, wherein the substrate comprises a wallcovering product.

36. The method of claim 23, wherein the substrate comprises a decorative laminate.

37. The method of claim 23, wherein the substrate comprises a floor covering.

38. An ink composition comprising the following ingredients:
i. an inorganic pigment colorant,
ii. a binder that is at least an ionomerically crosslinkable binder, and
iv. water.

39. The ink composition of claim 38, wherein the wherein the binder comprises a polymer having acid or acid precursor groups, the polymer having an acid number of at least about 3, and the ink composition further comprises an ionomeric crosslinking agent.

40. The ink composition of claim 38, wherein the ink composition comprises an environmentally friendly adjuvant.

41. The ink composition of claim 40, wherein the environmentally friendly adjuvant is a coalescing agent.

42. The ink composition of claim 41, wherein the coalescing agent comprises ethyl lactate.

43. The ink composition of claim 40, wherein the environmentally friendly adjuvant is an adhesion promoter.

44. The ink composition of claim 43, wherein the adhesion promoter comprises ethyl lactate.

45. The ink composition of claim 40, wherein the ink composition comprises less than 7% by weight N-methyl-2-pyrrolidone.

46. The ink composition of claim 41, wherein the ink composition comprises less than 4% by weight N-methyl-2-pyrrolidone.

47. A method of reducing the amount of N-methyl-2-pyrrolidone used in an ink composition, the method comprising the steps of:
a. determining an ink composition that uses N-methyl-2-pyrrolidone as an adjuvant; and
b. reformulating the ink composition by replacing a suitable amount of Nmethyl-2-pyrrolidone with an environmentally friendly adjuvant.

48. The method of claim 47, wherein the environmentally friendly adjuvant is a coalescing agent.

49. The method of claim 47, wherein the coalescing agent comprises ethyl lactate.

50. The method of claim 47, wherein the environmentally friendly adjuvant is an adhesion promoter.

51. The method of claim 50, wherein the adhesion promoter comprises ethyl lactate.

52. The method of claim 47, wherein the ink composition comprises less than 7% by weight N-methyl-2-pyrrolidone.

53. The method of claim 47, wherein the ink composition comprises less than 4% by weight N-methyl-2-pyrrolidone.
